(19) United States
(12) Patent Application Publication
(10) Pub. No.: US 2025/0340219 A1
(43) Pub. Date: Nov. 6, 2025

(54) LOCAL PATH PLANNING

(71) Applicant: Honda Motor Co., Ltd., Tokyo (JP)

(72) Inventors: Faizan M. TARIQ, San Jose, CA (US); Zheng-Hang YEH, San Jose, CA (US); Avinash SINGH, Santa Clara, CA (US); David F. ISELE, Sunnyvale, CA (US); Sangjae BAE, San Jose, CA (US)

(21) Appl. No.: 19/190,548

(22) Filed: Apr. 25, 2025

Related U.S. Application Data
(60) Provisional application No. 63/641,273, filed on May 1, 2024.

(51) Int. Cl. B60W 60/00; B60W 40/10

(52) U.S. Cl. CPC B60W 60/0027; B60W 40/10; B60W 2554/4041; B60W 2554/802

(57) ABSTRACT

According to one aspect, local path planning may include classifying an object within an operating environment as an upper bound object, a lower bound object, or infeasible based on a distance between a bounding box associated with the object and an upper environment feature, a distance between the bounding box associated with the object and a lower environment feature, and a cost function, generating a boundary associated with the object and the upper environment feature or the lower environment feature based on the classification of the object and boundary points of the bounding box associated with the object, and generating a local path planning trajectory for a vehicle based on the classification of the object, the boundary associated with the object, and transforming a kinematic model from a space-time domain to a space-only domain.

### CROSS REFERENCE TO RELATED APPLICATIONS

This application claims the benefit of U.S. Provisional Patent Application, Ser. No. 63/641,273 (Attorney Docket No. H1241111US01) entitled “EFFICIENT RISK-AWARE LOCAL PATH PLANNING FRAMEWORK FOR AUTONOMOUS DRIVING”, filed on May 1, 2024; the entirety of the above-noted application(s) is incorporated by reference herein.

### BACKGROUND

In the presence of oncoming traffic, an autonomous vehicle may deviate from a lane center to avoid a collision with vehicles parked on a side of the roadway. In the absence of a local path planning modification scheme, the autonomous vehicle may end up waiting an extended period of time for the parked vehicles to move before continuing on a pre-determined path.

### BRIEF DESCRIPTION

A system for local path planning may include a memory and a processor. The memory may store one or more instructions. The processor may execute one or more of the instructions stored on the memory to perform one or more acts, actions, and/or steps. For example, the processor may perform classifying an object within an operating environment as an upper bound object, a lower bound object, or infeasible based on a distance between a bounding box associated with the object and an upper environment feature, a distance between the bounding box associated with the object and a lower environment feature, and a cost function, generating a boundary associated with the object and the upper environment feature or the lower environment feature based on the classification of the object and boundary points of the bounding box associated with the object, and generating a local path planning trajectory for a vehicle based on the classification of the object and the boundary associated with the object.

The generating the local path planning trajectory for the vehicle may be based on transforming a kinematic model from a space-time domain to a space-only domain. The kinematic model may be a non-linear kinematic bicycle model. The generating the local path planning trajectory for the vehicle may be performed within a Frenet frame. The generating the local path planning trajectory for the vehicle may be based on obtaining kinematics of a kinematic model in a space-only domain in terms of a longitudinal distance step. The obtaining kinematics of the kinematic model may include applying a curvature-based model correction. The cost function may be based on a deviation from a reference path from a start region to a goal region, a steering effort, a local path planning trajectory curvature, and a distance to an environment boundary. When the object is a dynamic object, a predicted position for the object over a time horizon may be included as a convex cost in the cost function. The generating the local path planning trajectory for the vehicle may be based on a bounded slack variable accounting for perception noise. The system for local path planning may include an actuator implementing the local path planning trajectory for the vehicle.

A local path planning vehicle may include a memory and a processor. The memory may store one or more instructions. The processor may execute one or more of the instructions stored on the memory to perform one or more acts, actions, and/or steps. For example, the processor may perform classifying an object within an operating environment as an upper bound object, a lower bound object, or infeasible based on a distance between a bounding box associated with the object and an upper environment feature, a distance between the bounding box associated with the object and a lower environment feature, and a cost function, generating a boundary associated with the object and the upper environment feature or the lower environment feature based on the classification of the object and boundary points of the bounding box associated with the object, and generating a local path planning trajectory for the local path planning vehicle based on the classification of the object, the boundary associated with the object, and transforming a kinematic model from a space-time domain to a space-only domain. The local path planning vehicle may include an actuator implementing the local path planning trajectory for the local path planning vehicle.

The kinematic model may be a non-linear kinematic bicycle model. The generating the local path planning trajectory for the vehicle may be performed within a Frenet frame. The generating the local path planning trajectory for the local path planning vehicle may be based on obtaining kinematics of the kinematic model in terms of a longitudinal distance step. The obtaining kinematics of the kinematic model may include applying a curvature-based model correction.

A computer-implemented method for local path planning may include classifying an object within an operating environment as an upper bound object, a lower bound object, or infeasible based on a distance between a bounding box associated with the object and an upper environment feature, a distance between the bounding box associated with the object and a lower environment feature, and a cost function, generating a boundary associated with the object and the upper environment feature or the lower environment feature based on the classification of the object and boundary points of the bounding box associated with the object, and generating a local path planning trajectory for a vehicle based on the classification of the object and the boundary associated with the object.

The generating the local path planning trajectory for the vehicle may be based on transforming a kinematic model from a space-time domain to a space-only domain. The kinematic model may be a non-linear kinematic bicycle model. The generating the local path planning trajectory for the vehicle may be performed within a Frenet frame. The generating the local path planning trajectory for the vehicle may be based on obtaining kinematics of a kinematic model in a space-only domain in terms of a longitudinal distance step.

### BRIEF DESCRIPTION OF THE DRAWINGS

FIG. 1 is an exemplary flow diagram of a computer-implemented method for local path planning, according to one aspect.

FIG. 2 is an exemplary component diagram of a system for local path planning, according to one aspect.

FIG. 3 is an exemplary algorithm in association with the computer-implemented method for local path planning of FIG. 1 and the system for local path planning of FIG. 2, according to one aspect.

FIGS. 4A-4C are exemplary algorithms and logics in association with local path planning, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DR RAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

An “ego-vehicle”, as used herein, may describe an autonomous vehicle equipped with a system for local path planning, including sensors that perceive the operating environment around the ego-vehicle, described in greater detail herein. In other words, the “ego vehicle” is the autonomous vehicle that is being controlled by an autonomous driving system. It is noted, however, that the operating environment may include one or more other autonomous vehicles, not to be confused with the ego-vehicle.

A “vehicle system”, as used herein, may be any automatic or manual system that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

Path-speed decomposition-based trajectory planning schemes have garnered widespread usage in real-world robotics applications due to their efficacy and computational efficiency. While a global route or global path may be planned offline, generating a local path adaptive to real-time situations online remains desirable. A local path planning algorithm, which may be executed via a processor, a memory, a storage drive, a controller, and an actuator via a system for local path planning, is provided herein that prioritizes smoothness and low computational complexity, thereby facilitating scalability to dense environments with various on-road entities.

Motivated by the practical requirements of reliability and computational efficiency, the path-speed decomposition approach may be considered effective for various trajectory planning tasks (e.g., including local path planning). By separating the path generation and speed planning processes, the complexities of trajectory optimization may be broken down into manageable sub-problems to be tackled independently. The formulation of a path planning problem by the algorithm enables the problem to be solvable in real-time or within a short planning horizon (e.g., a couple of seconds). While this decomposition comes at a cost of discarding some trajectories where the path and speed are tightly coupled, the improved runtime provides the benefit of enabling vehicles to adapt to various driving scenarios, such as urban environments, highway cruising, or even off-road terrain, with greater precision and efficiency.

The system for local path planning may leverage the decomposition scheme to develop an efficient risk-aware local path planning strategy. For example, the processor may generate a global path at the outset of operation using map data. However, this global path may be created in the absence of local information, thereby creating a need for an updated route in real-time or at runtime. For example, parked vehicles on the roadside may cause deviation from the lane center specified by the global path. Concurrently, this deviated path should also ensure minimal disruption to oncoming vehicles. Therefore, an algorithm to generate efficient, smooth, and risk-aware deviation paths with respect to a fixed reference path to handle such situations is desired. The algorithm for local path planning may be implemented as a computer-implemented method 100 for local path planning and may simultaneously address path smoothness (e.g., resulting kinematic/dynamic feasibility) and computational efficiency as a practical benefit.

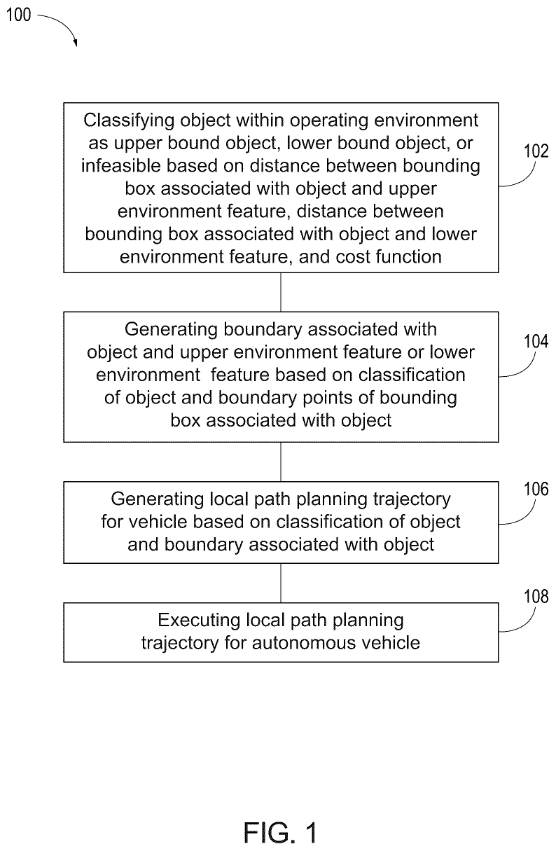

FIG. 1 is an exemplary flow diagram of a computer-implemented method 100 for local path planning, according to one aspect. The computer-implemented method 100 for local path planning may include classifying 102 an object within an operating environment as an upper bound object, a lower bound object, or infeasible based on a distance between a bounding box associated with the object and an upper environment feature, a distance between the bounding box associated with the object and a lower environment feature, and a cost function, generating 104 a boundary associated with the object and the upper environment feature or the lower environment feature based on the classification of the object and boundary points of the bounding box associated with the object, generating 106 a local path planning trajectory for a vehicle based on the classification of the object and the boundary associated with the object, and executing 108 or implementing the local path planning trajectory for an autonomous vehicle.

Generally, a system 200 for local path planning or a local path planning vehicle may generate a local path adaptive to one or more objects present along a reference path.

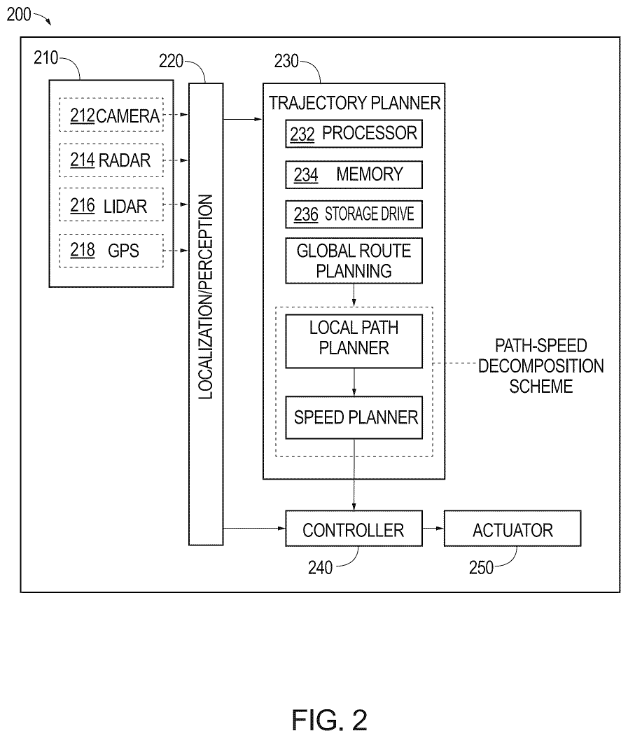

FIG. 2 is an exemplary component diagram of a system 200 for local path planning, according to one aspect. The system 200 for local path planning may include one or more sensors 210, such as a camera 212, radar 214, lidar 216, a global positioning system (GPS) 218, etc. The system 200 for local path planning may include a perception localizer and a trajectory planner 230. The trajectory planner 230 may be implemented via a processor 232, a memory 234, and a storage drive 236 to perform global route planning, local path planning, speed planning, etc. to generate a local path planning trajectory based on a path-speed decomposition scheme. Additionally, the system 200 for local path planning may include a controller 240 and an actuator 250. According to one aspect, the system 200 for local path planning may be implemented on a vehicle or an autonomous vehicle and may be a local path planning vehicle. The actuator 250 may implement the generated local path planning trajectory for the vehicle.

The perception localizer 220 and/or the trajectory planner 230 may be implemented via the processor 232, the memory 234, and the storage drive 236 to perform local path planning. The memory 234 may store one or more instructions. The storage drive may store the generated envelop graph. The processor 232 may execute one or more of the instructions stored on the memory 234 to perform one or more acts, actions, and/or steps described herein.

It may be seen from FIG. 2 that the system 200 for local path planning implements a modular architecture that decomposes the trajectory planning problem into two sub-problems (e.g., path planner and speed planner). This decoupled scheme facilitates the decomposition of the overall problem complexity, leading to the advantage of a computationally efficient trajectory local path planning algorithm. The first sub-problem includes devising a local path planning strategy that takes a predefined global path from the global route planner and dynamically adjusts it to accommodate real-time static objects. The global route planner may generate a global path for the ego-vehicle to reach its desired destination. For example, the global route planner may generate a reference path or global path from a start region to a goal region. This global path may be dynamically updated by a local path planner (e.g., implemented via the processor 232, the memory 234, and/or the storage drive 236) to cater to the environmental entities observed in real-time.

The second subproblem focuses on generating a speed profile along this locally modified path to cater to the dynamic objects. In this way, the system 200 for local path planning primarily addresses the first sub-problem, overview of the speed planning aspect for completeness. According to one aspect, a Multi-Profile Quadratic Programming (MPQP) approach may be implemented, leveraging a high level of mathematical rigor and optimality guarantees. The MPQP method includes projecting the objects onto a space-time graph, relative to the path generated by the local path planner and utilizing a breadth-first search to explore various timing possibilities, such as passing behind or ahead of an on-road agent. These options establish lower and upper bounds in space-time, which may then be enforced as constraints in a quadratic program. Notably, this approach maintains optimality without resorting to any additive approximations, thus yielding an optimal speed profile. However, any speed planner may be utilized.

### Local Path Planning

Given the global path (herein “reference path”), the processor 232 may generate a local path adaptive to one or more objects present along the reference path. In this way, the local planning framework may have the processor 232 perform classifying an object within an operating environment as an upper bound object, a lower bound object, or infeasible based on a distance between a bounding box associated with the object and an upper environment feature, a distance between the bounding box associated with the object and a lower environment feature, and a cost function, generating a boundary associated with the object and the upper environment feature or the lower environment feature based on the classification of the object and boundary points of the bounding box associated with the object, and generating a local path planning trajectory for a vehicle based on the classification of the object and the boundary associated with the object.

To bound the maximum deviation from the reference path, the processor 232 may utilize the Frenet-Serret frame relative to the reference path. In this frame, the longitudinal s-axis may be aligned with the reference path, while the lateral d-axis may indicate an orthogonal deviation from the reference path.

The sensors 210 may detect two or more objects (e.g., obstacles, pedestrians, other vehicles, cyclists, motorcyclists, static objects, etc.) within an operating environment.

### Bounding Box Generation

The processor 232 (e.g., perception localizer 220) may generate bounding box information for two or more bounding boxes corresponding to the two or more objects. The bounding box information may include a position, a size, and an orientation for a corresponding bounding box. Considering any noise in the data gathered from the perception localizer 220, consistent or updated measurements of objects' positions, orientations, and sizes may be useful for effective local path planning.

Two primary methodologies may be employed to address the perception noise in robust and probabilistic bounding box estimation. Both the robust and probabilistic bounding box generation strategies amidst noisy perception data. The robust approach includes creating a rectangle that encloses all perceived positions of the object, yielding robust guarantees. However, the conservative nature of the robust approach may lead to a “freezing robot problem”, potentially stranding the ego-vehicle unnecessarily. Alternatively, the probabilistic approach may include generating rectangles based on the real-time evaluation of noise distribution. In this regard, the probabilistic approach for bounding boxes may be implemented due to the simplicity and the balance between risk and consistency.

Let [symbol] denote a set of observable objects at a current time instant and let [symbol] denote the set of bounding boxes for all o∈ [symbol] . It may be assumed that the underlying distributions governing each bounding box's position, orientation, and size are independent Gaussians with known variances. Under this assumption, the processor 232 may obtain mean estimates of position, orientation, and size using the unbiased Maximum Likelihood Estimator, which corresponds a sample means. Formally, this may be represented as

$${\hat{k}}_{i} = \frac{1}{N} {\sum }_{n = 1}^{N} {\tilde{k}}_{i}^{n}$$

where N corresponds to the number of observed samples, \hat{k}₁ is a generic variable used to represent the estimated position, length, width, or orientation of a given bounding box, while

$${\tilde{k}}_{i}^{n}$$

represents the observed value of the variable under consideration. The size estimates may be further augmented by an additive margin to incorporate an extra buffer.

The estimated positions of pedestrians in the environment may be clustered using a density-based clustering algorithm. Then, for each individual cluster, vertices of a convex hull enclosing its respective constituents may be identified. Therefore, a bounding box with respect to these vertices, augmented by an additive margin, may be generated, and added to the set B. In any event, the bounding box information may be passed on to the trajectory planner 230, which may perform global route planning, local path planning, and speed planning.

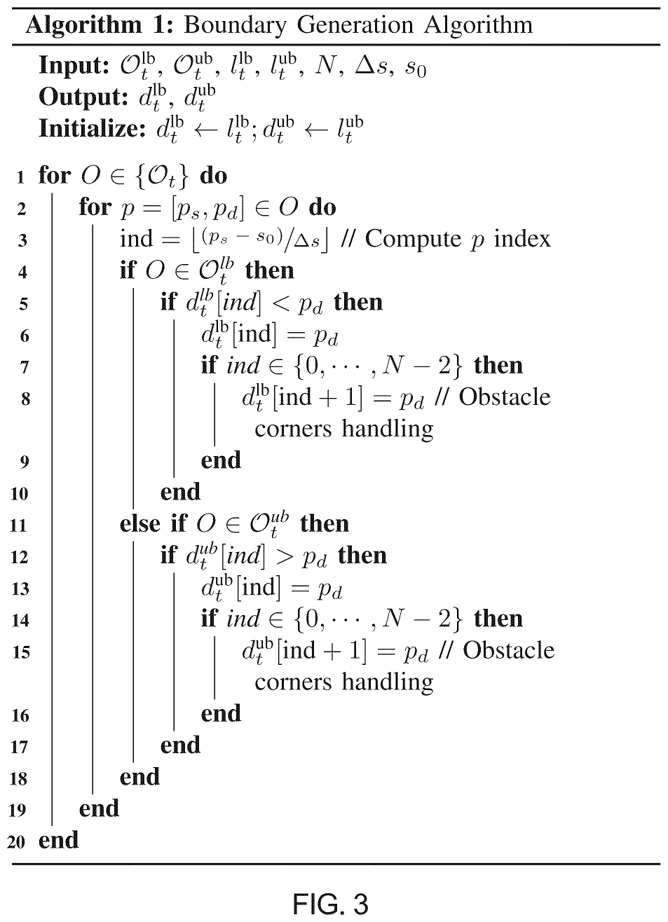

FIG. 3 is an exemplary algorithm in association with the computer-implemented method for local path planning of FIG. 1 and the system 200 for local path planning of FIG. 2, according to one aspect. The algorithm may be executed by the processor 232 to perform a computer-implemented method for local path planning.

### Frenet Corridor Planner (FCP) Including Data Processor (DP), Decision Governor (DG), and Path Optimizer (PO)

Motivated by the requirements for effectiveness and efficiency, path-speed decomposition-based trajectory planning methods have widely been adopted for autonomous driving applications. While a global route may be pre-computed offline, real-time generation of adaptive local paths remains useful. According to another aspect, another Frenet Corridor Planner (FCP), an optimization-based local path planning strategy for autonomous driving that ensures smooth and safe navigation around obstacles is provided herein. Modeling vehicles as bounding boxes and pedestrians as convex hulls in the Frenet space, this approach defines a drivable corridor by determining the appropriate deviation side for static obstacles. Thereafter, a modified space-domain bicycle kinematics model enables path optimization for smoothness, boundary clearance, and dynamic obstacle risk minimization. The optimized path may be passed to a speed planner to generate the final trajectory.

The FCP may be implemented via the processor 232, and be an efficient optimization-based path planning strategy that generates smooth paths around obstacles through a multi-stage process. Again, vehicles in the environment may be represented by bounding boxes, while pedestrian clusters may be modeled as convex hulls in the Frenet space. The appropriate deviation side may be determined by the processor 232 for each static obstacle, and the drivable region (e.g., corridors) for the ego-vehicle may be established. Next, an optimization problem may be solved by the processor 232 to generate a path that maximizes smoothness, maintains a safe distance from corridor boundaries, and aligns with the reference path while considering the risk associated with dynamic obstacles. This may be achieved using a modified space-domain bicycle kinematics model. Thereafter, the generated path may be passed to the speed planner to produce the overall trajectory.

### Frenet Coordinate System

The Frenet Coordinate System may be implemented, where the s-axis is representative of the longitudinal displacement along a given reference (global) path (ref), while the d-axis denotes the lateral displacement orthogonal to ref. Any point α∈ [symbol] ² may be transformed from the Cartesian to the Frenet frame using a non-linear transformation as follows:

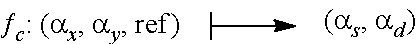

### System Architecture

### Motion Planning

The trajectory planning problem may be addressed using a decoupled scheme that tackles the path planning and speed planning problems independently. In other words, the processor 232 may decompose the overall problem complexity to yield an efficient trajectory planning algorithm. The generated trajectory may include both path and speed and may be forwarded to a downstream control module or controller, which may utilize a decoupled control scheme. Longitudinal control may be managed by a PID controller, tuned using a CARLA simulator, while lateral control may be handled by an MPC designed with a one-time-step planning horizon based on the vehicle rotation model.

### FCP Planning Pipeline Overview

The FCP may include one or more sub-modules that work together to generate a path for the downstream speed planning and control modules to follow and be implemented via the processor 232, the memory 234, the storage drive 236, etc. For example, the FCP may include a data processor (DP), a decision governor (DG), a boundary generator (BG), and a path optimizer (PO), which may also be implemented via the processor 232, the memory 234, the storage drive 236, etc.

The DP may process perception and localization data to extract obstacle-related information in the Frenet frame, which is then sent to the DG. The DG may determine the appropriate side to deviate each obstacle and forward this information to the BG. The BG may define the boundaries of the drivable region (e.g., corridor) and transmit them to the PO, which may generate a path using the proposed space domain kinematics model.

### Data Processor (DP)

The DP may take in the obstacles' state information (e.g., position, orientation, and size) from an external perception and localization module (e.g., sensors 210) to generate bounding boxes for vehicles and convex hulls for pedestrian clusters with the help of a density-based clustering algorithm (e.g., DBSCAN). Any pedestrian not associated with a cluster may be treated as an independent obstacle. At the current time t, the obstacle set containing the linearly interpolated points along the edges of the bounding boxes and convex hulls in the Frenet frame may be denoted by [symbol] ₜ.

### Decision Governor (DG)

In addition to having information on the locations and speeds of the obstacles present in the environment, FCP may request further information on the appropriate side of deviation for a static obstacle or object. Specifically, the FCP may request information related to whether a static obstacle should be considered in the upper or lower boundary of the corridor, and this information may be provided b the DG. Therefore, DG partitions the obstacle set (Oₜ) into disjoint lower

$$( {𝒪}_{t}^{lb} )$$

and upper

$$( {𝒪}_{t}^{ub} )$$

) bound obstacle sets such that:

$${O}_{t} = {𝒪}_{t}^{ub} ⋃ {𝒪}_{t}^{ub} and {𝒪}_{t}^{ub} ⋂ {𝒪}_{t}^{ub} = ∅ .$$

In this way, the processor 232 may classify an object within an operating environment as an upper bound object, a lower bound object, or infeasible based on a distance between a bounding box associated with the object and an upper environment feature, a distance between the bounding box associated with the object and a lower environment feature, and a cost function.

### Path Planning

The efficacy of FCP may be demonstrated with a simple decision tree for the DG. This simple decision tree performs well even with moderate noise in the perception and localization data. However, with large noise, this may cause inconsistent obstacle classification (e.g., switching between lower and upper bounds), especially when an obstacle is located near the center of the drivable space.

Alternatively, the obstacle may be treated as a risk in the PO to enhance path consistency. Other methods may be incorporated into DG to improve the robustness of the trajectory planning pipeline.

### Boundary Generator (BG)

The BG takes in

$${𝒪}_{t}^{lb} and {𝒪}_{t}^{ub}$$

as well as the lower and upper road limits,

$${l}_{t}^{lb} and {l}_{t}^{ub} ,$$

to generate the lower and upper bounds,

$${d}_{t}^{lb} and {d}_{t}^{ub} ,$$

in the Frenet space for a planning horizon of N steps with a longitudinal spacing of As meters, resulting in a planning distance of L=N×Δs meters. The boundary generation algorithm, outlined in Algorithm 1 of FIG. 3, identifies the “extremum” d-value for each obstacle point at the queried s-positions. Therefore, only a single pass over the obstacle points may result in a runtime complexity of [symbol] (Nₒ) where Nₒ corresponds to the sum of the number of boundary points for all obstacles in [symbol] ₜ.

### Path Optimizer (Po)

A path at a current time step t may be defined as

$${P}_{t} = [ {p}_{t}^{1} , … , {p}_{t}^{N} ]$$

where N denotes the number of waypoints and

$${p}_{t}^{i} ∈ {ℝ}^{2} {∀}_{i} ∈ \{ 1 , … , N \}$$

denotes a waypoint in space.

### Space Domain Kinematics Model

Since the goal may be to generate Pₜ, the processor 232 may transform or consider the vehicle kinematic model from the space-time to space-only domain, thereby reducing the problem's complexity. For the base model, the non-linear kinematic bicycle model may be utilized due to its accuracy and efficiency.

In the Cartesian Frame, the states, Xₜ, and the control inputs, Uₜ, of the ego-vehicle at time instant t are given by Xₜ=[xₜ yₜψₜ vₜ]^{T}∈ [symbol] ₜ and Uₜ=[aₜ δₜ]_{T}∈ [symbol] ₜ, respectively. Here, xₜ, yₜ, ψₜ, and vₜ respectively denote the x-coordinate (m), y-coordinate (m), yaw angle with respect to the x-axis (rad), and speed (m/s), whereas a(k) and δ(k) respectively denote acceleration (m/s²), and steering angle (rad). The sets [symbol] ₜ= [symbol] ²× [symbol] _{[0,2π)}× [symbol] _{[0,V}_{^{max]}} and

$${𝕌}_{t} = {ℝ}_{[ {U}^{min} , {U}^{max} ]}^{2} ,$$

respectively, denote the feasible states and the actuation limits. Then, the system dynamics read:

$${x}_{t + 1} = {x}_{t} + {v}_{t} cos ( {ψ}_{t} + {β}_{t} ) Δ t \qquad ( 36 )$$

$${y}_{t + 1} = {y}_{t} + {v}_{t} sin ( {ψ}_{t} + {β}_{t} ) Δ t \qquad ( 37 )$$

$${ψ}_{t + 1} = {ψ}_{t} + \frac{{v}_{t}}{{l}_{r}} sin β t Δ t \qquad ( 38 )$$

$${v}_{t + 1} = {v}_{t} + {a}_{t} Δ t \qquad ( 39 )$$

where t denotes the temporal index, Δt denotes the sampling timestep, and

$${β}_{t} = {tan}^{- 1} ( \frac{{l}_{r}}{{l}_{f} + {l}_{r}} tan {δ}_{t} )$$

maps the steering input (δₜ) to the vehicle orientation (ψₜ). Now, to remove the time dependence, the distance step may be fixed as lₜ=vₜΔt. Moreover, since the spatial domain is being explored, the time-varying speed vₜ may be disregarded and the constant distance step may be fixed as lₜ=Δl, giving the following modified kinematics model:

$${x}_{k + 1} = {x}_{k} + cos ( {ψ}_{k} + {β}_{k} ) Δ l \qquad ( 40 )$$

$${y}_{k + 1} = {y}_{k} + sin ( {ψ}_{k} + {β}_{k} ) Δ l \qquad ( 41 )$$

$${ψ}_{k + 1} = {ψ}_{k} + \frac{1}{{l}_{r}} sin {β}_{k} Δ l \qquad ( 42 )$$

where k denotes the spatial index. Now, the kinematics model may be given in terms of the fixed “arc length” step along the path, denoted by Δl. However, in order to have a uniform correspondence between the path and the upper and/or lower bounds, the kinematics model may be reformulated such that the independent variable is the constant “longitudinal distance” step (Δs), instead of Δl to facilitate the direct integration of

$${d}_{t}^{lb} and {d}_{t}^{u b} ,$$

generated by the BG, into the PO.

For the optimization problem, the bounds

$${d}_{t}^{lb} and {d}_{t}^{ub}$$

may be defined at each “knot” of the path Pₜ, which necessitates the reformulation of the kinematics model in terms of the independent Δs variable.

With the updated set of states given by \tilde{X}ₖ=[xₖ yₖ ψₖ]^{T}, the modified kinematics model may be governed only by the control input δₖ∈ [symbol] _{[δ}_{^{min}}_{,δ}_{^{max}}_{]}.

Now, assuming that are working in the Frenet frame, may obtain the kinematics in terms of the “longitudinal distance” step by introducing the following non-linear transformation (projection): Δs=Δ—l cos(ψₖ+βₖ). The kinematics model may read:

$$\begin{matrix}{x}_{k + 1} = {x}_{k} + Δ s \\ {y}_{k + 1} = {y}_{k} + \frac{sin ( {ψ}_{k} + {β}_{k} )}{cos ( {ψ}_{k} + {β}_{k} )} Δ s\end{matrix} \qquad ( 43 )$$

$$= {y}_{k} + tan ( {ψ}_{k} + {β}_{k} ) Δ s \qquad ( 44 )$$

$${ψ}_{k + 1} = {ψ}_{k} + \frac{Δ s}{{l}_{r}} \frac{sin {β}_{k}}{cos ( {ψ}_{k} + {β}_{k} )} \qquad ( 45 )$$

The kinematics model may not be posed for ψₖ+βₖ=π/2. This corresponds to a path Pₜ orthogonal to ref. In the Frenet frame, each point along such a path has the same s value, while the path is not defined for any others value, leading to a singularity.

The bicycle kinematic model does not translate directly from the Cartesian to the Frenet frame due to a non-linear transformation with respect to ref. To address this, a curvature-based model correction may be introduced to ensure conformance of the Cartesian-based kinematic model to the Frenet space.

βₖ is defined as:

$${β}_{k} = arctan ( \frac{{l}_{r}}{{l}_{f} + {l}_{r}} tan {δ}_{k} ) \qquad ( 46 )$$

which is non-linear. To linearize, approximate:

$${β}_{k} \approx \frac{{l}_{r}}{{l}_{f} + {l}_{r}} {δ}_{k} \qquad ( 47 )$$

This approximation is kinematically valid (feasible) only if

$$\frac{{l}_{r}}{{l}_{f} + {l}_{r}} \vert {δ}_{k} \vert$$

under-approximates |βₖ|. Otherwise, the approximated kinematics with the maximum steering angle δₘₐₓ may not be feasible. Thus, it is shown that

$$\vert {β}_{k} \vert \geq \frac{{l}_{r}}{{l}_{f} + {l}_{r}} \vert {δ}_{k} \vert ∀ {δ}_{k} ∈ ( - \frac{π}{2} , \frac{π}{2} ) .$$

For brevity, subscript k is omitted in the following proof:

$$f ( δ ) = arctan ( a tan δ ) - a δ \qquad ( 48 )$$

where

$$a = \frac{{l}_{r}}{{l}_{f} + {l}_{r}} ∈ [ 0 , 1 ] .$$

It is desired to show that

$$f ( δ ) \geq 0 ∀ δ ∈ [ 0 , \frac{π}{2} )$$

and that

$$f ( δ ) \leq 0 ∀ δ ∈ ( - \frac{π}{2} , 0 ] .$$

The derivative reads:

$${f}^{′} ( δ ) = \frac{a {sec}^{2} δ}{1 + {a}^{2} {tan}^{2} δ} - a \qquad ( 49 )$$

$$= \frac{a}{{cos}^{2} δ + {a}^{2} {sin}^{2} δ} - a \qquad ( 50 )$$

$$= a ( \frac{1 - ( {cos}^{2} δ + {a}^{2} {sin}^{2} δ )}{{cos}^{2} δ + {a}^{2} {sin}^{2} δ} ) \qquad ( 51 )$$

Given a∈[0,1], the following suffices for all δ (proof is trivial):

$${cos}^{2} δ + {a}^{2} {sin}^{2} δ \leq 1 \qquad ( 52 )$$

Thus, ƒ′(δ)≥0, indicating ƒ is a monotonically increasing function. When δ=0, ƒ(δ)=0. Due to the monotonicity, for δ>0, ƒ(δ)≥0, e.g.,

$$f ( δ ) = arctan ( a tan δ ) - δ \geq 0 \qquad ( 53 )$$

$$↔ arctan ( a tan δ ) \geq δ \qquad ( 54 )$$

Similarly, it may be proved for

$$δ ∈ ( - \frac{π}{2} , 0 ] .$$

In practice, especially for normal highway driving where a vehicle is not pushed to actuation limits, the steering range is generally around [−0.6,0.6] rad within which the approximation holds.

### Actuation Limit Induced by Reference Path'S Curvature

Thus far, the bicycle kinematic model has been transformed into a space-only kinematic model with longitudinal space sampling. However, there is not yet an account for ref's curvature in the formulation, which is useful for converting the kinematic model from the Cartesian to the Frenet space. Neglecting this curvature may lead to kinematic infeasibility, making it difficult for the vehicle to follow the computed path. To address this, the processor 232 may directly impose a curvature limitation on the path-planning problem by restricting the feasible actuation set using the angle changes along ref at each step k, given as Δψ̅k.

Based on the kinematics model, the change in heading angle (45) at any step k reads:

$${Δψ}_{k} = \frac{Δ s}{{l}_{r}} \frac{sin {u}_{k}}{cos ( {ψ}_{k} + {u}_{k} )} \qquad ( 55 )$$

which is lower bounded by

$$\frac{Δ s}{{l}_{r}} tan {u}_{k}$$

for

$$\vert {ψ}_{k} + {u}_{k} \vert < \frac{p i}{2} where {u}_{k} = \frac{{l}_{r}}{{l}_{f} + {l}_{r}} {δ}_{k} .$$

$$Δ {\overline{ψ}}_{k} \approx \frac{Δ s}{{l}_{r}} tan {u}_{k}$$

may be approximated to over-constrain the feasible set for the steering input. Consequently, the steering required to follow ref reads:

$${\overline{u}}_{k} = arctan ( \frac{{l}_{r}}{Δ s} Δ {\overline{ψ}}_{k} ) \qquad ( 56 )$$

Thereafter, the control bounds in (64) are restricted as:

$${u}_{k} + {\overline{u}}_{k} ∈ [ {u}^{min} , {u}^{max} ] ∀ k \qquad ( 57 )$$

$$where {u}^{min / max} = \frac{{l}_{r}}{{l}_{f} + {l}_{r}} {δ}^{min / max} .$$

### Non-Linear Optimization Problem

Using the reformulated Frenet space bicycle kinematics model and the spatial corridor boundaries,

$${d}_{t}^{lb} and {d}_{t}^{u b} ,$$

obtained through the BG, the path planning optimization problem may be posed as follows:

$${min}_{u} {d}^{T} {Q}_{d} d + {u}^{T} {Q}_{u} u + {λ}_{c u r v e} {\sum }_{k} {tan}^{2} {u}_{k} + {λ}_{r i s k} {\sum }_{k} {( {d}_{k} - \frac{{d}_{{t}_{k}}^{lb} + {d}_{{t}_{k}}^{u b}}{2} )}^{2} \qquad ( 58 )$$

subject to:

$${s}_{k + 1} = {s}_{k} + Δ s \qquad ( 59 )$$

$${d}_{k + 1} = {d}_{k} + tan ( {ϕ}_{k} + {u}_{k} ) Δ s \qquad ( 60 )$$

$${ϕ}_{k + 1} = {ϕ}_{k} + \frac{Δ s}{{l}_{r}} \frac{sin {u}_{k}}{cos ( {ϕ}_{k} + {u}_{k} )} \qquad ( 61 )$$

$${d}_{{t}_{k}}^{lb} \leq {d}_{k} \leq {d}_{{t}_{k}}^{u b} \qquad ( 62 )$$

$${s}_{0} = {\hat{s}}_{t} , {d}_{0} = {\hat{d}}_{t} , {ϕ}_{0} = {\hat{ϕ}}_{t} \qquad ( 63 )$$

$${u}_{k}^{min} \leq {u}_{k} \leq {u}_{k}^{max} \qquad ( 64 )$$

for all k∈{0, . . . , N−1} where d=[d₁, . . . , dₖ]^{T}, u=[u₁, . . . , uₖ]^{T}, N is the number of planning steps, operator \hat{ }(hat) denotes the current measurement, the set

$$ℝ [ {u}_{k}^{min} , {u}_{k}^{max} ]$$

denotes actuation limits incorporating the limits induced by ref's curvature (57), and Q and λ denote penalty weight matrix and scalar, respectively. The objective function in (58) penalizes: (i) deviation from the global route (e.g., ref corresponds to d=0 in the Frenet frame), (ii) steering effort, (iii) path curvature, and (iv) distance to boundaries.

To ensure computational efficiency, the optimization problem may be formulated with a convex objective function and no inequality constraints, making the kinematics model the only source of non-convexity. This may be achieved by replacing the non-convex collision avoidance inequality constraints with the precomputed corridor bounds. While the kinematics model could be linearized, at the cost of model accuracy, to formulate a convex problem, it was found that this linearization was unnecessary considering the strong computational performance.

### Dynamic Obstacle Handling

Generating boundaries for dynamic obstacles (e.g., using Algorithm 1, FIG. 3) may lead to recursive infeasibility as fluctuating behaviors and predictions overtime may cause the upper and lower bounds to intersect. Therefore, dynamic obstacles may be treated as additive risks in the optimization problem. Specifically, each predicted position over a given time horizon may be included as a convex cost in the optimization cost (58). Therefore, the additive penalty reads:

$${r}_{dyn} = {λ}_{dyn} {\sum }_{i ∈ \{ 1 , … , {N}_{t}^{dyn} \}} {\sum }_{k} \frac{1}{{( {\hat{d}}_{k}^{( i )} - {d}_{k} )}^{2}} \qquad ( 65 )$$

where Δ_{dyn} is the penalty weight,

$${N}_{t}^{dyn}$$

is the number of dynamic obstacles within the planning space at the current time t, and

$${\hat{d}}_{k}^{( i )}$$

is the predicted lateral (center of mass) position of a dynamic obstacle i at step k. Thus, when the object is a dynamic object, a predicted position for the object over a time horizon may be included as a convex cost in the cost function. The pipeline may be based on a path-speed decomposition method, so the speed planner guarantees safety in space-time with respect to dynamic obstacles.

### Perception Noise Handling

In the presence of perception noise, the existing optimization problem may become infeasible, especially when the ego-vehicle is located close to the corridor boundaries. To ensure problem feasibility, a bounded slack variable may be introduced for the bounds in (62) as:

$${d}_{{t}_{k}}^{lb} - {α}_{k} \leq {d}_{k} \leq {d}_{{t}_{k}}^{u b} + {α}_{k} \qquad ( 66 )$$

where αₖ≤α̅ with a fixed α̅. Then, add a slack penalty term in (24) as

$${λ}_{α} {\sum }_{k} {α}_{k}^{2}$$

with λ_{α}>>0.

In this way, the generating the local path planning trajectory for the vehicle may be based on a bounded slack variable accounting for perception noise.

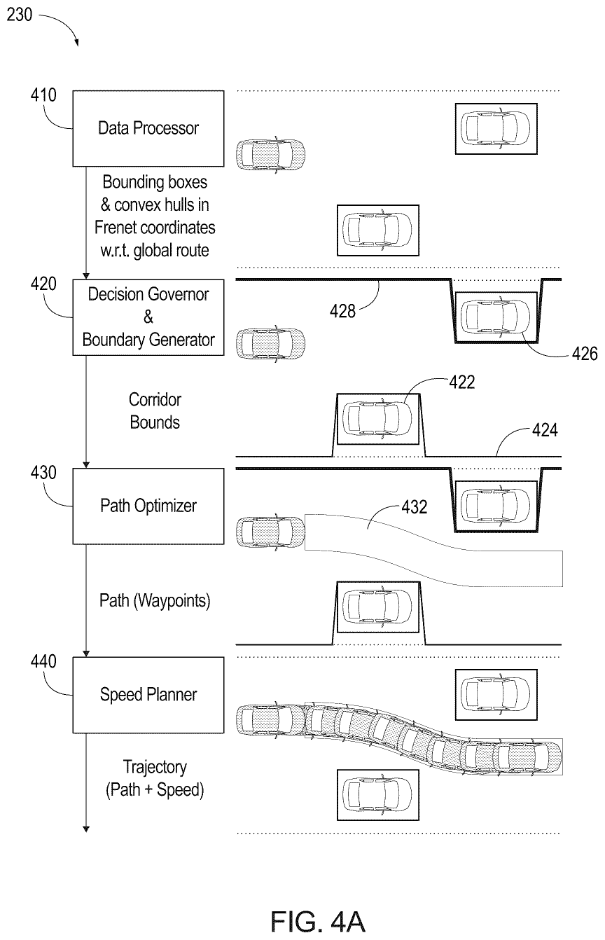

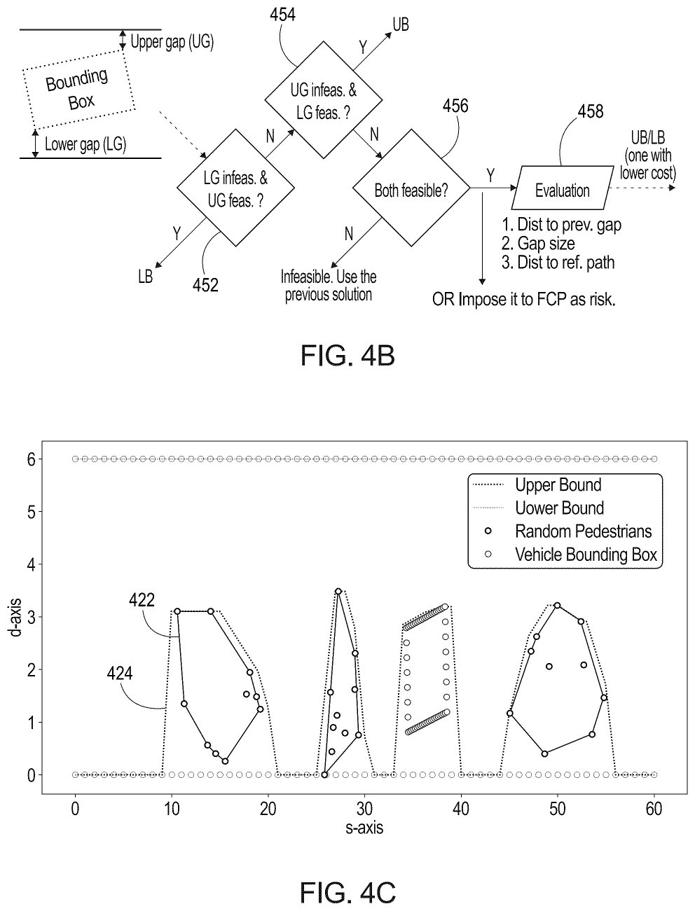

FIGS. 4A-4C are exemplary algorithms and logics in association with local path planning, according to one aspect. With reference to FIG. 4A, the processor 232 may receive relevant information 410 regarding a position of the ego-vehicle, a position of an object within the operating environment, a bounding box associated with the ego-vehicle, a bounding box associated with the object, convex hull information, etc. This information may be provided in Frenet coordinates with regard to the reference path or the global reference path. The processor 232 may include a decision governor 420 classifying the object within an operating environment as an upper bound object, a lower bound object, or infeasible based on a distance between a bounding box associated with the object and an upper environment feature, a distance between the bounding box associated with the object and a lower environment feature, and a cost function. For example, object 422 may be classified by the processor 232 as a lower bound object and object 426 may be classified as an upper bound object.

With reference to FIG. 4B, a given object may be classified as an upper bound object, a lower bound object, or infeasible according to the decision tree provided. For example, for the object shown in FIG. 4B, if a lower gap (LG) between a bounding box of the object and a lower environment feature is less than a threshold distance (e.g., a width of the ego-vehicle or a similar distance) and an upper gap (UG) between the bounding box of the object and an upper environment feature is greater than the threshold distance, the object may be classified 452 by the processor 232 as a lower bound object. If the LG between a bounding box of the object and a lower environment feature is greater than the threshold distance and the UG between the bounding box of the object and the upper environment feature is less than the threshold distance, the object may be classified 454 by the processor 232 as an upper bound object. If the LG between a bounding box of the object and a lower environment feature is less than the threshold distance and the UG between the bounding box of the object and the upper environment feature is less than the threshold distance, the object may be classified 454 by the processor 232 as infeasible (e.g., the ego-vehicle may not be able to pass the object at a current time). If the LG between a bounding box of the object and a lower environment feature is greater than the threshold distance and the UG between the bounding box of the object and the upper environment feature is greater than the threshold distance, the object may be classified 456 by the processor 232 based on a cost function 458. The cost function 458 may include factors such as a distance to a previous gap, a gap size for the UG or the LG, a distance to the reference path, etc. Additionally, the cost function 458 may be based on a deviation from a reference path from a start region to a goal region, a steering effort, a local path planning trajectory curvature, and a distance to an environment boundary.

Returning to FIG. 4A, the processor 232 may include a boundary generator at 420. The boundary generator may generate a boundary associated with the object and the upper environment feature or the lower environment feature based on the classification of the object and boundary points of the bounding box associated with the object. As seen in FIG. 4A, a boundary 424 may be generated for the lower bound object 422 and a boundary 428 may be generated for the upper bound object 426. FIG. 4C illustrates another example of boundary generation 424 for multiple lower bound objects 422.

The path optimizer 430 may be the local path planner from the trajectory planner 230 of FIG. 2 and may generate a local path planning trajectory 432 for a vehicle based on the classification of the object and the boundary associated with the object. Finally, the speed planner 440 may generate speed planning aspects for the local path planning trajectory 432. The generating the local path planning trajectory for the vehicle may be based on transforming a kinematic model from a space-time domain to a space-only domain. The kinematic model may be a non-linear kinematic bicycle model. The generating the local path planning trajectory for the vehicle may be performed within a Frenet frame. The generating the local path planning trajectory for the vehicle may be based on obtaining kinematics of a kinematic model in a space-only domain in terms of a longitudinal distance step. The obtaining kinematics of the kinematic model may include applying a curvature-based model correction.

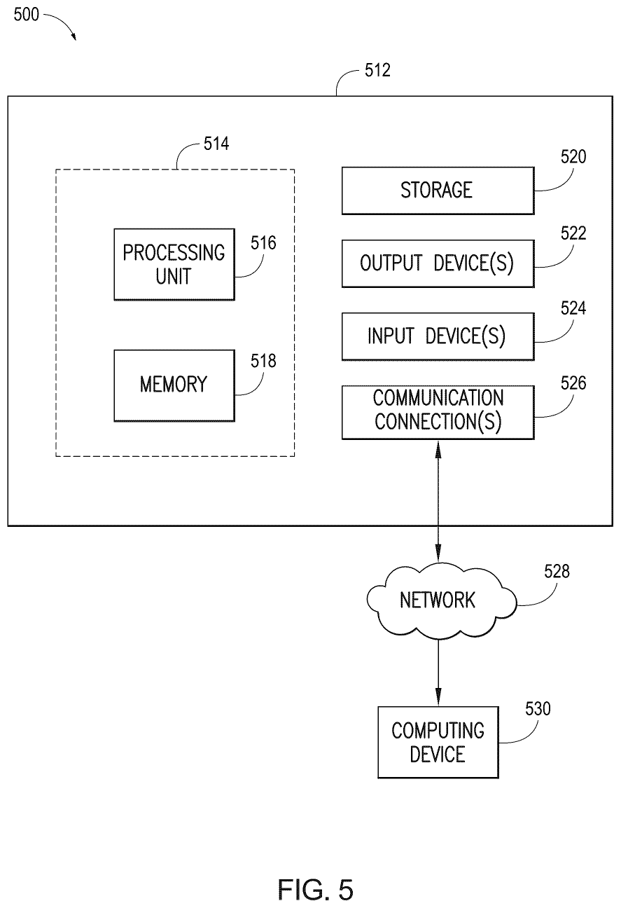

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

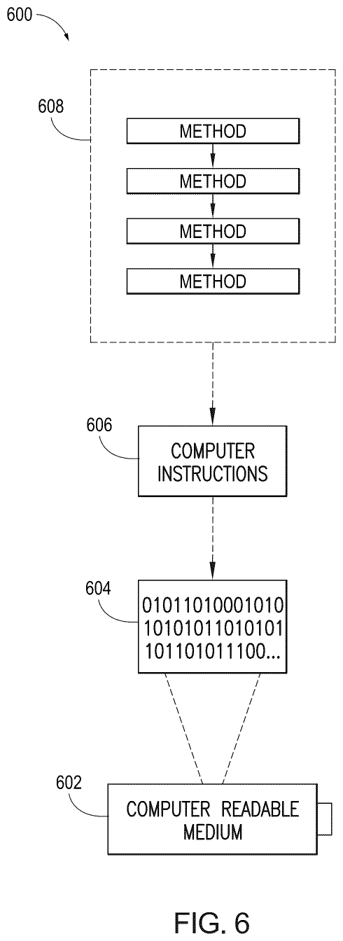

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 100 for local path planning of FIG. 1. In another aspect, the processor-executable computer instructions 606 may be configured to implement a system, such as the system 200 for local path planning of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for local path planning, comprising:
a memory storing one or more instructions; and
a processor executing one or more of the instructions stored on the memory to perform:
classifying an object within an operating environment as an upper bound object, a lower bound object, or infeasible based on a distance between a bounding box associated with the object and an upper environment feature, a distance between the bounding box associated with the object and a lower environment feature, and a cost function;
generating a boundary associated with the object and the upper environment feature or the lower environment feature based on the classification of the object and boundary points of the bounding box associated with the object; and
generating a local path planning trajectory for a vehicle based on the classification of the object and the boundary associated with the object.

2. The system for local path planning of claim 1, wherein the generating the local path planning trajectory for the vehicle is based on transforming a kinematic model from a space-time domain to a space-only domain.

3. The system for local path planning of claim 2, wherein the kinematic model is a non-linear kinematic bicycle model.

4. The system for local path planning of claim 1, wherein the generating the local path planning trajectory for the vehicle is performed within a Frenet frame.

5. The system for local path planning of claim 1, wherein the generating the local path planning trajectory for the vehicle is based on obtaining kinematics of a kinematic model in a space-only domain in terms of a longitudinal distance step.

6. The system for local path planning of claim 5, wherein the obtaining kinematics of the kinematic model includes applying a curvature-based model correction.

7. The system for local path planning of claim 1, wherein the cost function is based on a deviation from a reference path from a start region to a goal region, a steering effort, a local path planning trajectory curvature, and a distance to an environment boundary.

8. The system for local path planning of claim 1, wherein when the object is a dynamic object, a predicted position for the object over a time horizon is included as a convex cost in the cost function.

9. The system for local path planning of claim 1, wherein the generating the local path planning trajectory for the vehicle is based on a bounded slack variable accounting for perception noise.

10. The system for local path planning of claim 1, comprising an actuator implementing the local path planning trajectory for the vehicle.

11. A local path planning vehicle, comprising:
a memory storing one or more instructions;
a processor executing one or more of the instructions stored on the memory to perform:
classifying an object within an operating environment as an upper bound object, a lower bound object, or infeasible based on a distance between a bounding box associated with the object and an upper environment feature, a distance between the bounding box associated with the object and a lower environment feature, and a cost function;
generating a boundary associated with the object and the upper environment feature or the lower environment feature based on the classification of the object and boundary points of the bounding box associated with the object; and
generating a local path planning trajectory for the local path planning vehicle based on the classification of the object, the boundary associated with the object, and transforming a kinematic model from a space-time domain to a space-only domain; and
an actuator implementing the local path planning trajectory for the local path planning vehicle.

12. The local path planning vehicle of claim 11, wherein the kinematic model is a non-linear kinematic bicycle model.

13. The local path planning vehicle of claim 11, wherein the generating the local path planning trajectory for the vehicle is performed within a Frenet frame.

14. The local path planning vehicle of claim 11, wherein the generating the local path planning trajectory for the local path planning vehicle is based on obtaining kinematics of the kinematic model in terms of a longitudinal distance step.

15. The local path planning vehicle of claim 14, wherein the obtaining kinematics of the kinematic model includes applying a curvature-based model correction.

16. A computer-implemented method for local path planning, comprising:
classifying an object within an operating environment as an upper bound object, a lower bound object, or infeasible based on a distance between a bounding box associated with the object and an upper environment feature, a distance between the bounding box associated with the object and a lower environment feature, and a cost function;
generating a boundary associated with the object and the upper environment feature or the lower environment feature based on the classification of the object and boundary points of the bounding box associated with the object; and
generating a local path planning trajectory for a vehicle based on the classification of the object and the boundary associated with the object.

17. The computer-implemented method for local path planning of claim 16, wherein the generating the local path planning trajectory for the vehicle is based on transforming a kinematic model from a space-time domain to a space-only domain.

18. The computer-implemented method for local path planning of claim 17, wherein the kinematic model is a non-linear kinematic bicycle model.

19. The computer-implemented method for local path planning of claim 16, wherein the generating the local path planning trajectory for the vehicle is performed within a Frenet frame.

20. The computer-implemented method for local path planning of claim 16, wherein the generating the local path planning trajectory for the vehicle is based on obtaining kinematics of a kinematic model in a space-only domain in terms of a longitudinal distance step.
